(19) United States
(12) Patent Application Publication
(10) Pub. No.: US 2004/0151622 A1
(43) Pub. Date: Aug. 5, 2004

(54) Ultra-trace automatic mercury species analyzer

(76) Inventor: Chun-Mao Tseng, Miaoli Hsien (TW)

Correspondence Address: BACON & THOMAS, PLLC, 625 SLATERS LANE, FOURTH FLOOR, ALEXANDRIA, VA, 22314

(21) Appl. No.: 10/747,116

(22) Filed: Dec. 30, 2003

(30) Foreign Application Priority Data
Dec. 31, 2002 (TW) 091221541

(51) Int. Cl. G01N 21/64

(52) U.S. Cl. 422/52; 422/80

(57) ABSTRACT

A novel Ultra-trace Automatic Mercury Species Analyzer (AMSA) is a semi-automatic or automatic on-line dual-channel detection device. The principle of the methodology is on-line coupling of analytical stages (or set-ups) with cold vapor atomic detector using flow injection analysis technique. This analyzer can be fully automatic for fast and accurate monitoring Hg species of natural environmental samples in ultra-trace levels. Furthermore, the AMSA is well suitably used in laboratory or other field stations (e.g., shipboard uses etc.) It provides ease of operation, fast analysis, high analytical performance, and excellent data quality. There is no risk of contamination with ambient air and no need of ultra-clean class-100 room to obtain the high quality data on ultra-trace mercury species analyses (e.g., Hg⁰, Hg²⁺, monomethyl Hg, dimethyl Hg etc.) in natural environmental samples (e.g., air, water, sediment, soil, vegetation, bio-tissues and other sample types).

### BACKGROUND OF THE INVENTION

(a) Field of the Invention

The present invention relates to a novel design of ultra-trace automatic mercury species analyzer (AMSA), which replaces the traditional and complex manual-handling analyses of Hg species through the use of flow-injection valves. Several advantages are gained in terms of simplicity, efficiency, precision, accuracy and versatility. It can be easily employed in the general laboratory or in the field (e.g., shipboard) with any risk of ambient contamination because the analyses are conducted within a closed circuit. This analyzer can be accurately performed in Hg speciation analysis (e.g., elemental, reactive and total Hg and methyl-Hg species) for different environmental samples (e.g., air, water, sediment, bio-tissues etc.). The design can be further applied to multi-sample analysis from on-line dual-channel detection system to multi-channel one (e.g., several sampling traps with only one analytical trap).

(b) Description of the Prior Art

Based on the consideration of public health and ecological problems, it desperately needs to monitor the contents of Hg species, especially very toxic methyl-Hg, in natural environmental and biological samples. Nevertheless, to obtain accurately environmental Hg measurements is analytically challenging and difficulty. First, the concentration of Hg is extremely low, ca. fM (10⁻¹⁵ mole/L), so that ultra-clean sampling and proper analytical techniques (e.g., purging, preconcentration, separation, desorption and quantification) are required. Second, problems such as contamination and Hg species change (e.g., Hg⁰ production/loss) could occur during sampling and storage. Third, the distribution of Hg species varied temporally and spatially so that real-time, field measurements are needed.

Commonly used methods based on the “two-stage amalgamation” approach (US EPA standard method #1631A), for instance, involve manual handling, as well as analytical set-ups that are not on-line hyphenated, resulting in an analysis time over 30 minutes per sample and an increased risk of leaks in the analytical train during purging and analysis. Additional concerns include blank control, potential contamination by laboratory air containing high Hg levels and gas Hg losses during sample introduction. In general, the traditional manual approaches do not fulfill the analytical and field requirements in an efficient manner (i.e., there are major drawbacks related to quality control and assurance, duration of analysis and complexity).

The aforementioned two-stage gold amalgamation technique, based on the property of Au being capable to absorb gas-phase Hg⁰, is successfully used for the determination of the environmental Hg. A thin layer of Au film is plated on the surface of fine sand or glass bead. The Au-coated sand is then placed within a quartz tube as a preconcentration trap for trapping Hg⁰, which can be further quantified by an atomic detector. The key features of this approach, which is consisted of two traps, e.g., one sample trap and another analytical trap, are to eliminate the potential interferences and to avoid contamination of sample traps down-stream. Additionally, the efficiency and recovery for the sample trap can be calibrated simply by comparison to a stable and good quality analytical trap via gas Hg standard injection during the analyses.

A general procedure for determining inorganic Hg (Hg²⁺) in aqueous samples is, for example, described herein. In general, two subsystems are used for dissolved Hg²⁺ analysis: 1) the purging/reaction device for stripping Hg⁰, which is converted through reduction by SnCl₂, onto a gold (Au) trap, and 2) an analytical set-up for measuring Hg⁰. Briefly, the analytical steps are as follows. First, dissolved Hg²⁺ is converted to gaseous Hg⁰ through reacting with reducing agent and then collected on an Au-coated sand trap (termed the “sample trap”) while purging the water samples with inert gas such as nitrogen (N₂). If gaseous mercury is collected from air sample, the gaseous mercury is directly pumped into the sample traps. Second, the sample trap is removed from the purging vessel and placed into an argon (Ar) carrier stream to help remove water vapor after completion of the purging step. Third, the sample trap is then connected in series with an “analytical trap” in an Ar line. Fourth, the Hg⁰ is thermally desorbed about 600° C. from the “sample” trap and carried onto the “analytical” trap via the Ar stream. Finally, detection of Hg⁰ is achieved with an atomic fluorescence detector following thermal desorption (˜600° C.) from the “analytical” trap. Such a dual-stage amalgamation technique has worldwide recognition and is the basis for the US EPA Standard Method #1631.

Thereby, the prior dual-stage amalgamation technique is mainly carried out by manual operation and desperately needed a large number of laboratory apparatus. Therefore, not only the operation is inconvenient but also the measurement can't be performed real-time. Consequently, analytical performance of the Hg measurement is affected in terms of precision and accuracy.

### SUMMARY OF THE INVENTION

Accordingly, the primary objective of the present invention is to provide an automatic ultratrace mercury species analyzer, comprising at least two injection valves, an atomic detector, and a flow meter; characterized in that as follows: 1) The injection valves are multi-way flowing valves. The flowing directions of the injection valves are versatile. Each one of injection valves has a trap, either as analytical or sample traps, which both are wrapped with a heating device for desorpting mercury collected on Au-coated sand. 2) An atomic detector is used for measuring mercury and installed after the injection valve having an analytic trap; and 3) A flow meter serves for measuring and controlling flow rate of Ar gas between two injection valves. An automatic ultratrace mercury species analyzer is thus made through the on-line coupling of all the components based on the flow injection technique. All analytical stages from sample transfer to final detection are connected on-line in a flow manifold using Teflon tubing (mostly 3.2 mm o.d) and fittings. The lengths of transfer lines were minimized to prevent condensation.

The rationales and advantages of the present invention will be more readily expressed and unveiled from the following detailed description along with the interpretation of appended drawing.

### BRIEF DESCRIPTION OF THE DRAWINGS

FIG. 1 shows the system layout that the present invention is used to determine mercury species.

FIG. 2 shows the semi-automatic injection valve of the present invention.

FIG. 3 shows the automatic injection valve of the present invention.

FIG. 4 is a schematic showing that the injection valve is switched to the “trap” position according to the present invention.

FIG. 5 is a schematic showing that the injection valve is switched to the “desorption” position according to the present invention.

FIG. 6 shows an arrangement for measuring organic mercury species according to the present invention.

FIG. 7 shows another arrangement for mercury speciation analysis according to the present invention.

FIG. 8 is a schematic showing one demonstration of the present invention with an installation of an air pump.

FIG. 9 is a schematic showing one demonstration of the present invention with the use of purging vessels.

### DETAILED DESCRIPTION OF THE PREFERRED EMBODIMENTS

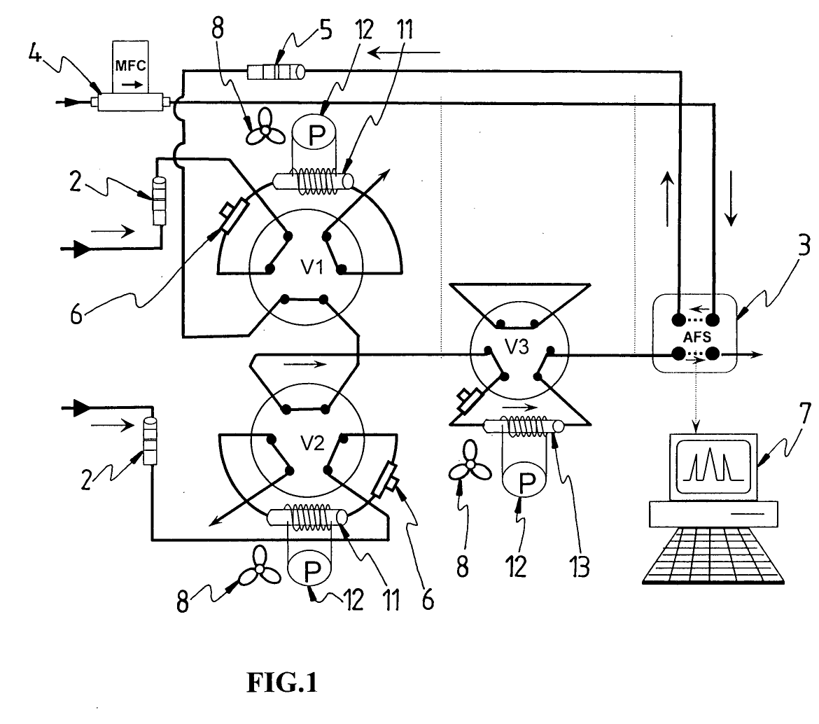

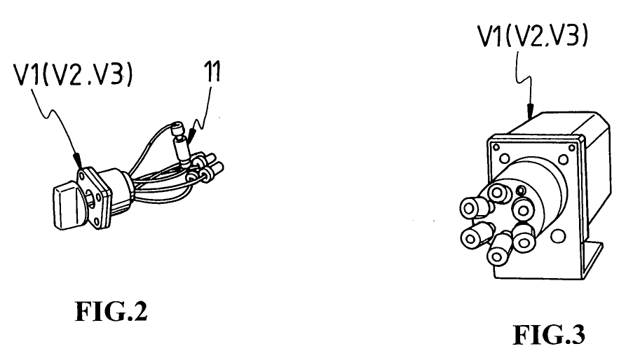

Referring to FIG. 1 the automatic ultratrace mercury species analyzer of the present invention is illustrated. The present invention is a semi-automatic or fully automatic on-line dual channel detection system. The analyzer of the present invention mainly comprises three injection valves v1, v2, and v3, one pre-cleaning trap 2, one detector 3, one gas flow meter 4, one pre-purifying trap 5, and one injection tee 6 which are connected through Teflon tubing of 3.2 mm o.d and fittings. The three injection-v1, -v2, and -v3 can be semi-automatic or full-automatically multi-functional valves, each leading to an Au-coated sand column (either the sample or analytical trap), are used to control the trapping and desorption of Hg⁰ in a two-stage Au amalgamation gas train as shown in FIGS. 2 and 3. Those three valves can be six-, ten- or multi-way valves. Each of the valves v1 and v2 is connected to an individual trap, i.e., sample trap 11. Inside of the sample trap 11 is packed with mercury absorbents, such as Au-coated sand for absorbing Hg⁰ or organic absorber, e.g., Tenax-A for trapping organic Hg species, such as monomethyl Hg, dimethyl Hg, etc. The Hg absorbents are selectively chosen according to the requirement and purpose of experiment. The sample trap 11 is wrapped with a nickel-chrome (Ni—Cr) wire attached to a variable transformer for voltage control. The coil can be heated to ˜600° C. for desorbing Hg⁰ trapped on the sample trap. Furthermore, valves v1 (or v2) is positioned so that concentrated Hg⁰ can be loaded onto the analytical trap located in valve v3 through carrier gas Ar flow.

The injection-v3 is the same as the injection-v2 leading to a Au sand trap 13 i.e., analytical trap for isolating it in “stand-by” position of a closed loop without Ar flow or for by-passing Ar gas in “desorption” position. The analytical trap 13 is also wrapped by a Ni—Cr coil, which is attached to a transformer. Upon heating of this column to 600° C., the desorbed Hg⁰ on the analytical trap directly enters the atomic detector for Hg⁰ detection.

The layout of present invention may be arranged with one injection-v1 (e.g., either six-, ten- or multi-way) and one injection-v3. One ten-way valve rather than six-way one is, for example, used for dual channel detections. Moreover, with additional valves, multiple sample analyses can be simultaneously operated giving high sample throughput through the extended present invention (e.g., with several sampling traps).

The pre-cleaning trap 2 works for removing or eliminating water vapor or volatile organic materials before sample gas stream contacted the sample trap 11. While inorganic Hg analysis is performed, the pre-cleaning trap 2 is packed with reagent grade Soda lime and Tenax-TA (graphized carbon) in separate section may be set in-line after a Teflon syringe filter or Dryer Tube (e.g., Nafion dryer, Perma Pure for removing water vapor). When organic Hg species analysis is made, only Soda lime is packed in the pre-cleaning trap 2 without Tenax-TA. Two pre-cleaning traps 2 are respectively connected to the valves v1 and v2 and are separately positioned before the injection Tee 6 and sample trap 11.

The cold vapor atomic detector 3 is used to detect gas-phase Hg⁰. The detector 3 can be an atomic fluorescence spectrometer and is connected to the outlet of the injection-v3 using Teflon tubing.

The flow meter 4 controls and measures the mass flow of the carrier Ar gas flowing through between the injection-v1, -v2, and -v3 and in the whole system.

The pre-purifying trap 5 works for removing the gas-phase Hg species in the carrier Ar gas in order to reduce the blank which affects the analytical reliability. The pre-purifying trap 5 is packed with Hg absorbents, i.e., Au-coated sand for gas-phase Hg⁰ and organic absorbents, such as Tenax-TA or charcoal for trapping volatile organic Hg species together.

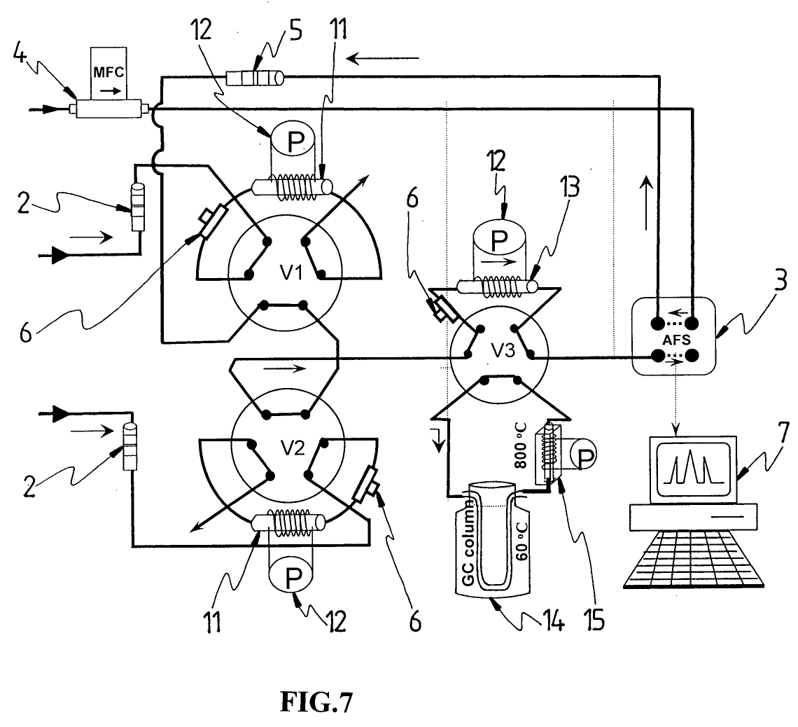

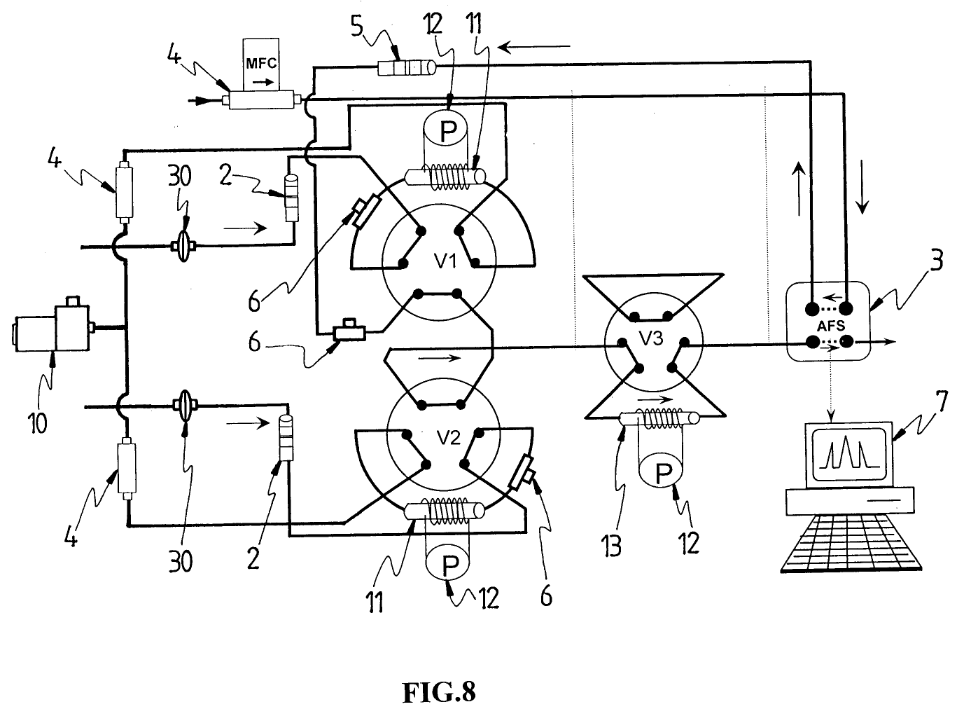

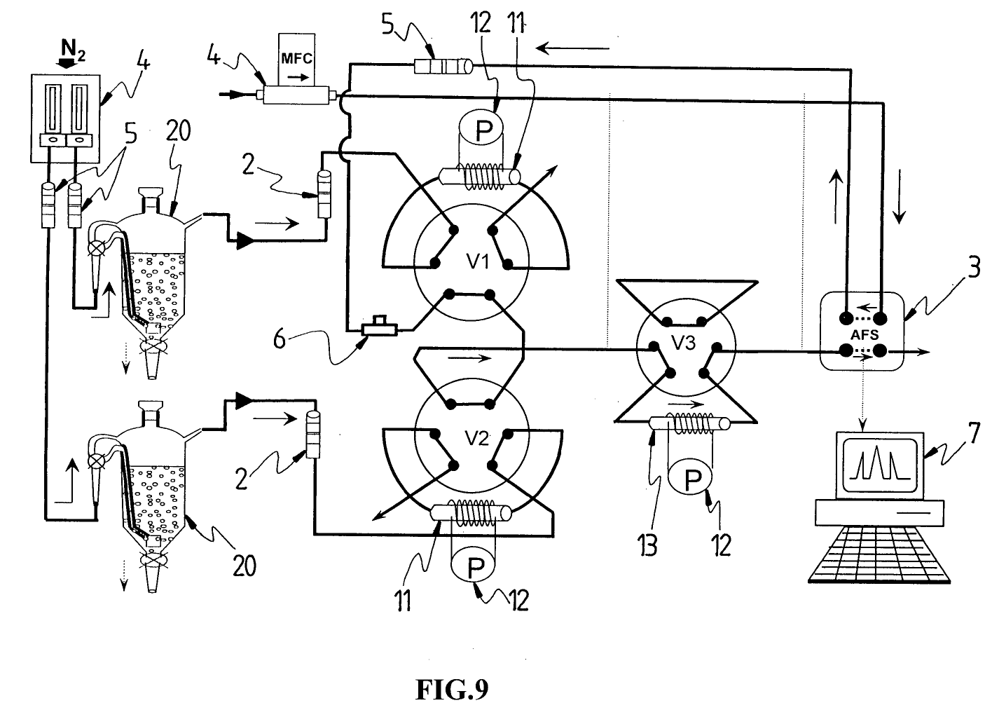

The T-shape injection port 6 can be a manual or automatic Teflon injection tee 6 and operated to quantify Hg analysis through the injection of Hg⁰ gas standard. That is, a known mass of a Hg⁰ gas standard is injected into the Ar carrier or sample gas stream through a injection tee prior to sample or analytical traps. The injection tee 6 may be placed between the pre-purifying trap 5 and the injection-v1, as shown in FIG. 9. Alternatively, three injection tees 6 can be set before the sample traps 11 and analytic trap 13 of the valve loops v1, v2, and v3 (referring to FIG. 1 or 7). Or, three injection tees 6 can be arranged: Two of them 6 are placed before the sample traps 11 of the loops of the valves v1, v2, and another set between the injection-v1 and the pre-purifying trap 5 (see in FIG. 8).

The three injection-v1, -v2, and -v3, a pre-cleaning trap 2, an atomic detector 3, a flow meter 4, a pre-purifying trap 5, and a injection tee 6 are used to assemble the present invention. The valve v3 is arranged after the outlets of the two valves v1, v2. Each analytical component is orderly arranged in a case box. Therefore, the automatic ultratrace mercury species analyzer of the present invention is made.

The characteristic feature of the AMSA of the present invention is summarized as follows. Firstly, the AMSA can be made from the conventionally manual operation of the dual-stage amalgamation to the automatic one giving high quality of analytical performance. Secondly, one single channel design can be extended to dual channel operations, even more channels with additional valves, so that two sample analyses can be carried out at the same time. Sample mercury, once converted to gas-phase Hg, can be concentrated simultaneously to both of sample traps 11. Continuous measurements can be performed in two separate channel lines (i.e., one flowing through the channel line #1 of injection-v1 and -v3 and the other flowing through the channel #2 of injection-v2 and -v3) for Hg analysis and sample loading. Detection and loading are continuously and alternatively proceeding through the control of computer with a customized software.

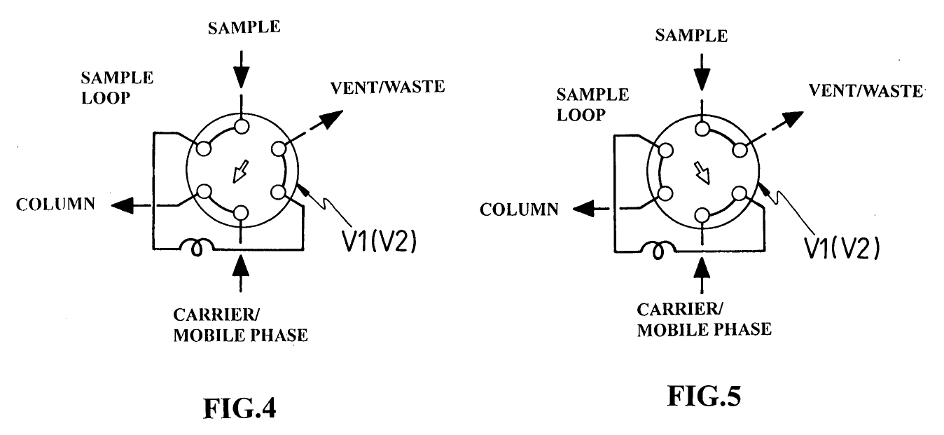

The operation procedure of the present invention will be briefly illustrated as follows by taking the channel #1 as an example (see FIG. 1). Before the sample gas stream passes through the sample traps 11, it will flow through the pre-cleaning trap 2 for pre-purifying the gas-phase Hg⁰. The pre-trap is used to remove water vapor and volatile organic compounds which cause potential interferences during the analysis. The gas stream then flows through the injection tee 6 and the sample traps 11 set in the loop of injection-v1. Gas-phase Hg⁰ is finally amalgamated on the packed Au-coated sand (ca. 0.25 g, 60˜80 mesh) in the sample trap 11 and other sample gas vents from the system via injection-v1. Once gas-phase Hg⁰ is collected at a detectable range, injection-v1 is turned from the “trap” position (amalgamating Hg⁰ in the sample trap) to the “desorption” position (ready to desorb Hg⁰ onto the analytical trap). The operations of the injection valve have two functions in trapping and injection mode, referring to FIGS. 4 and 5. Moreover, injection-v3 is turned also at the same time with injection-v2 from the “stand-by” position to the “trap/desorb” position. In the “stand-by” position, the analytical trap is isolated in a closed loop without Ar flow. At this time, the whole circuit of the system is in a carrier Ar gas stream. Namely, the Ar gas flows through the traps 11 and 13 of the loops of injection-v1 and -v3 and it is then ready for the next proceeding analyses of heating the traps. After 1 min of flow stabilisation, Hg⁰ trapped on the sample trap 11 is desorbed by heating to ˜600° C. The Ar stream (30 mL min⁻¹) then carries the Hg⁰ to the analytical column 13 of the injection-v3 loop, where it again amalgamates into the surface layer of the Au. Subsequently (about 2 minutes later), upon heating of this analytical trap 13 to 600° C. for 1 minute, the desorbed Hg⁰ directly enters the cold vapour atomic detector 3. Detection of Hg⁰, for example, by atomic fluorescence takes place at the excitation of 253.7 nm. The flow rate of the carrier Ar gas, a Hg-free gas, is controlled by the mass flow meter 4 in the whole traveling path. The carrier gas before entering the whole system will firstly be purified through by the purifying trap 5. The analytical signal is finally recorded as peak area and quantified using a personal computer with chromatographic software 7. The analytical process for Hg⁰ analysis, from the flow stabilization, desorption, detection to data acquisition, takes 5 minutes and is fully automatically controlled by a programmable software 7. During the analysis of 5 min, the next sample can be loaded up for subsequent trapping. In the present invention, a small fan 8, as shown in FIG. 1, is used for cooling the traps after both of the sample traps 11 and analytic trap 13 are heated. It is also controlled automatically through a computer software 7. Thereby, by the present invention, the one channel dual-stage amalgamation can be fully automatic and conveniently performed in the laboratory or field such as shipboard use.

In the present invention, two additional injection-v1 and -v2 with enclosing sample traps 11 are installed. The alternating and continuous analyses can be made in orderly. That is, when the analysis of channel #1 start running, operations of sample loading and trapping in channel #2 can be subsequently performed which is the same as those for channel #1 described above. Later, during the process of channel #2 measurement, sample loading and trapping of gas-phase Hg⁰ unto the sample trap 11 can be simultaneously carried out in channel #1. Once the Hg⁰ has been trapped to a detectable extent, the succeeding measurement can be done immediately. Similarly, during the process of measurement of channel #1, the sampling and trapping of Hg⁰ can be performed in the channel #2. Such repeated and alternating processes make the collection and measurement of Hg⁰ being performed in a continuous and efficient manner using the AMSA of the present invention. Likewise, in the present invention, if a number of injection valves with sample traps 11 are assembled with one injection-v3, the operation is the same as described above.

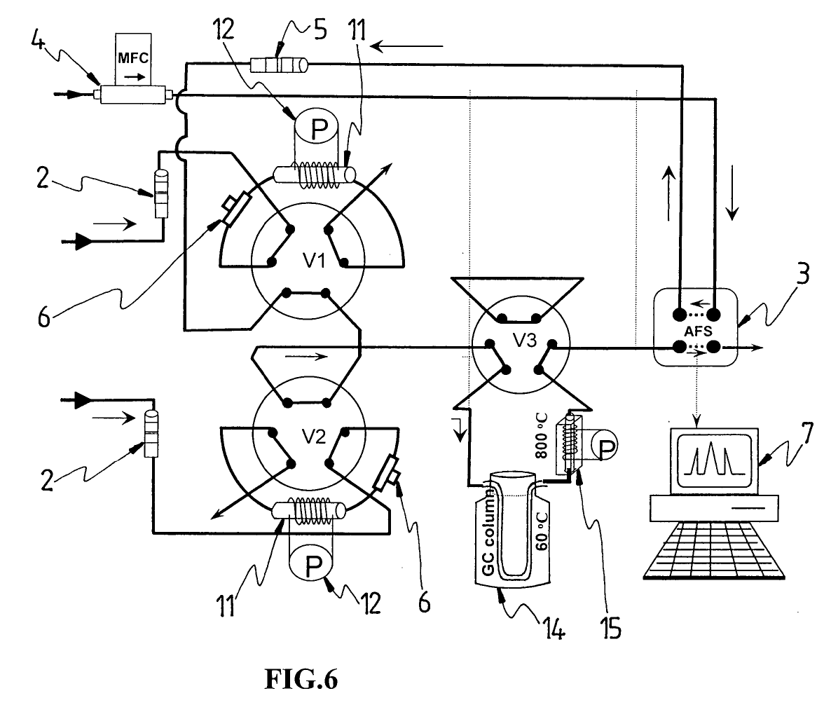

In aforementioned description, Au-coated sand is mainly used for the analysis of inorganic Hg. If organic Hg species is measured, the fillings in the sample traps 11 shall be changed to organic absorbents such as Tenax-TA. Moreover, other experimental conditions must be modified. The heating of Nichrome wire to the sample trap 11 is, for example, only to 300° C. The flow rate of carrier gas, heating mantle (about 150° C.) wrapping the injection tee 6, and analysis time are adjusted as well. Furthermore, gas chromatographic separation system 14 and atomization quartz tube 15 (heated to 800° C.) are used to replace with the analytic trap 13 in the loop of the injection-v3 for further Hg speciation analysis ie., the measurement of organo-Hg species. The above description can refer to FIG. 6 which method principle, structure and operation of the AMSA is the same as those illustrated in FIG. 1.

FIG. 7 shows one schematic layout, which is the combination of the embodiments shown in FIGS. 1 and 6. In FIG. 7, the analytic trap 13, and gas chromatographic system 15 and atomization quartz tube 16 are placed at two sides of the injection-v3 loops, respectively. This layout can be used to measure organic or inorganic Hg species or both. According to the modifications of experimental condition settings (e.g., the rotation of injection-v3, replace of sample traps 11), the Hg measurements can be versatile to meet the need of environment monitoring. In this embodiment, automatic selection and switching for multifunctional Hg speciation analysis can be achieved with the additional valves and selective sample traps 11 as well.

The aforementioned AMSA is intended for operation with laboratory apparatus that process water, soil, vegetation, and other sample types. The peripheral devices can be assembled on-line as desired for Hg speciation analysis such as Hg⁰, Hg²⁺, monomethylmercury (MMHg), Dimethymercury (DMHg), etc. If gas-phase Hg⁰ in air and related species are analyzed, a small pump 10 (see FIG. 8) is used to suck the air sample into the sample traps 11. The gas-phase Hg⁰ is collected unto Au-sand of sample traps 11. Other air gas is vented out. Preferably, the air pump 10 is set following the outlets of the injection-v1, -v2. Between the injection-v1, -v2 and pump 10 are connected with respective flow meters 4 for controlling flow rate of the air that flows through the traps of the injection-v1, -v2. Moreover, each of air inlets of the injection-v1, -v2 is connected with a Teflon syringe filter disk or multi-stage filtration disk 30 for preventing fine particles and water vapors to enter into the sample traps 11. Thereby, by a simple assembly, an analyzer for monitoring the environmental air Hg can be made.

If Hg species in aqueous sample are analyzed, a gas-liquid separator (GLS) or purging vessel 20 is needed for derivatization and purging processes. It may have a size of 50 mL to as large as 2 L. The size and shape are flexible based on objectives of the measurement, as shown in FIG. 9. The aqueous sample is firstly transferred into the GLS either under N₂ pressure or by manual. Derivatizing reagents (e.g., SnCl₂ for Hg²⁺, NaBET₄ or NaBH₄ for organic Hg species) are then added into the sample of a GLS from the top and then allow reaction and purging for a couple of minutes. The Hg-free N₂ stream (purified by a trap containing Au-sand and Carbotrap) is routed through a glass frit (˜20 μm porosity) at the bottom of GLS to strip out the volatile Hg species from the aqueous phase. The derivatization (e.g., non-volatile Hg species converted to volatile species) takes place during the purging. Inorganic Hg²⁺ is, for example, reduced to a gas-phase Hg⁰; methyl-Hg is ethylated to volatile organic Hg compound by using NaBET₄. After a period time of purging, volatile Hg species are completely collected in the sample traps 11 (e.g., Hg⁰ amalgamated on the Au-coated sand) and nitrogen gas then vented from the system via an injection-v1 or -v2. The whole analysis can be performed in orderly fashion of the AMSA via the control of a computer. When two injection-v1, -v2, or more are used in the present invention, at least two GLS 20 are installed in the inlets of the injection-v1, v2 (FIG. 9). A flow meter 4 is then placed before each GLS 20 for controlling the stripping flow. After the stripping nitrogen gas flows through the purifying trap 5, the impurities, acidity and water vapors in the gas stream can be removed/diminished for reducing interference in the measurement. Through such simple hyphenation, a continuous Hg auto-analyzer is made.

In above AMSA, after assembled with other auxiliary devices, the dual-channel approach can be applied for air and aqueous samples, respectively, or for proceeding in the following manner: one channel to measure aqueous sample and the other for measuring air samples. The AMSA becomes a ship-going or underway Hg analyzer as a Hg⁰ flux terminator. All functions of the AMSA are flexibly based on experiment purposes required. All assemblies and analytical stages from sample transfer to final detection are connected on-line in a flow manifold using Teflon tubing (mostly 3.2 mm o.d) and fittings. The lengths of transfer lines were minimized to prevent condensation during analysis and improve efficiency in detection. All the analyses are performed in a fully closed Ar stream with no risk of leak and air contamination so that reliable data can be obtained, even in bad field circumstances such as mountain, ship, airplane, etc.

In the present invention, the conventional, laborious, manual and off-hyphenated one-channel dual stage amalgamation is realized into an on-line automatic dual-channel analyzer. The number of injection valves having sample traps 11 may be 3, 4, or even ten (i.e., a number of sample traps are connected to an analytic trap 13). It is possible that only one injection valve having a sample trap 11 is coupled with an injection-v3 with one analytic trap 13. The design of the present invention is versatile for multi-functional purposes to gain high analytical performance.

In conclusion, the ANISA of the present invention described above is evidently a novel design other than conventional and commercial systems for the ultra-low level Hg analysis. The structure frame and analytical performance of the AMSA is robust and concise and its effectiveness fulfills the goal of the expected design for environment real-time analysis as well. I trust, therefore, you will find this AMSA quite suitable for US patent application. The present invention, thus described, may be obviously varied in many ways. Certain variations are, however, not to be regarded as a different approach from the spirit and scope of the present invention, and all such modifications as would be obvious to one skilled in the art are intended to be included within the scope of the following claims.

What is claimed is:

1. An ultra-trace Automatic Mercury Species Analyzer (AMSA), comprising at least two injection valves, an atomic detector, and a flow meter; characterized in that as follows:
1) The injection valves are multi-way flowing valves. The flowing directions of the injection valves are versatile. Each one of injection valves has a trap, either as analytical or sample traps, which both are wrapped with a heating device for desorpting mercury collected on Au-coated sand. The injection valve having analytic trap is arranged after outlets of the injection valves having sample traps;
2) An atomic detector is used for measuring mercury and installed after the injection valve having an analytic trap; and
3) A flow meter serves for measuring and controlling flow rate of Ar gas between two injection valves.
The AMSA is thus made through the on-line coupling of all the components based on the flow injection technique. All analytical stages from sample transfer to final detection are connected on-line in a flow manifold using Teflon tubing (mostly 3.2 mm o.d) and fittings.

2. The AMSA as claimed in claim 1, wherein it may allow expending the design with more additional injection valves having sample traps for the multi-channel analysis; these injection valves having sample traps are commonly connected before the injection valve having the analytic trap.

3. The AMSA as claimed in claim 1, wherein each injection valve is a semiautomatic or full automatic valve.

4. The AMSA as claimed in claim 1, wherein each injection valve is one of 6-, 10-, and 12-way injection valves.

5. The AMSA as claimed in claim 1, wherein the sample traps are packed with mercury absorbents selectively according to the experimental purpose and requirement.

6. The AMSA as claimed in claim 5, wherein the mercury absorbent is Au-coated sand, bead or cartridge for absorbing gas-phase Hg⁰.

7. The AMSA as claimed in claim 5, wherein the mercury absorbent is graphized carbon material for absorbing organic Hg compounds.

8. The AMSA as claimed in claim 1, wherein each of the heating devices is a Ni—Cr wire coil attached to a variable transformer of voltage control.

9. The AMSA as claimed in claim 1, wherein the sample trap is connected to a pre-cleaning trap for removing and purifying the interferences such as water vapor and volatile organic materials before the sample gas contacts the sample trap.

10. The AMSA as claimed in claim 1, wherein a purifying trap is installed after the atomic detector and before the injection valve having a sample trap for removing gas-phase Hg species in the carrier Ar gas so as to reduce the blank background in the analysis.

11. The AMSA as claimed in claim 1, wherein a Teflon injection tee, either in manual or automatic manner, is placed in a certain selective position for quantifying Hg analysis through the injection of Hg⁰ gas standard.

12. The AMSA as claimed in claim 11, wherein the injection tee is mounted after the purifying trap and before the injection valve.

13. The AMSA as claimed in claim 11, wherein there are a number of injection tees. Each injection tee is mounted before the sample trap and analytic trap within the loop of each injection valve.

14. The AMSA as claimed in claim 11, wherein there are a number of injection tees. Each injection tee is mounted before the Hg traps within the loop of each injection valve; and one of the injection tees is mounted after the purifying trap and before the injection valve.

15. The AMSA as claimed in claim 1, wherein the analytic trap is replaced by a gas chromatographic system and an atomization quartz tube for measuring organic mercury species.

16. The AMSA as claimed in claim 1, wherein the analytic trap and a gas chromatographic system with an atomization quartz tube are respectively placed in each side of the loop of the injection valve for measuring inorganic mercury and organic mercury species.

17. The AMSA as claimed in claim 1, wherein the cold vapor atomic detector is an atomic fluorescence spectrometer.
